(19) United States
(12) Patent Application Publication
(10) Pub. No.: US 2012/0113232 A1
(43) Pub. Date: May 10, 2012

(54) MULTIPLE CAMERA SYSTEM AND METHOD FOR SELECTABLE INTERAXIAL SEPARATION

(75) Inventor: George Joblove, Hollywood, CA (US)

(73) Assignees: SONY PICTURES TECHNOLOGIES INC., Culver City, CA (US); SONY CORPORATION, Tokyo (JP)

(21) Appl. No.: 13/291,067

(22) Filed: Nov. 7, 2011

Related U.S. Application Data
(60) Provisional application No. 61/412,314, filed on Nov. 10, 2010.

(51) Int. Cl. H04N 13/02

(52) U.S. Cl. 348/48; 348/E07.085

(57) ABSTRACT

Systems and methods are provided for 3-D photography. Multiple cameras or lens and sensor assemblies are employed to provide a range of interaxial separations. A user selects two of such cameras to achieve a desired interaxial separation, the two cameras separated by an interaxial separation closest to that desired. The systems and methods may be applicable to even low-cost consumer-grade still and video cameras to provide stereoscopic 3-D effects.

### CROSS-REFERENCE TO RELATED APPLICATIONS

This application claims benefit of priority of U.S. Provisional Patent Application Ser. No. 61/412,314, filed Nov. 10, 2010 entitled “Multi-Eye 3D Camera For Selectable Interaxial Separation”, owned by the assignee of the present application and herein incorporated by reference in its entirety.

### BACKGROUND OF THE INVENTION

Stereoscopic 3-D photography and cinematography involves the use of two cameras or optical assemblies to create two images, which will ultimately be displayed using any of various methodologies for presenting one of the camera's views to a viewer's left eye and the other to the viewer's right eye, simulating binocular vision of the original scene. The distance between the optical centers of the two cameras or optical assemblies is termed the interaxial separation, or “IA”.

Because the interaxial separation affects the appearance of the scene as well as viewer's perception of the stereo imagery, and because the ideal IA may differ between different scenes, it is desirable in a stereoscopic camera system adjust the IA, both to provide the photographer or cinematographer creative flexibility and to allow the selection of an IA suitable to the nature of the scene. For example, for scenes in which the subject is distant, an IA that approximates human intraocular or pupillary separation may be preferred, on average about 6 or 7 cm, while for close-ups such a wide IA tends to yield imagery that is uncomfortable to view, and a narrower IA of, say, 2 cm may be preferable.

FIG. 1 illustrates a prior art system 10 in which a camera A (12a) and a camera B (12b) are separated by an interaxial separation IA_{AB}. The camera 12a is shown in highly schematic form, as being formed from an assembly including a lens 14a and an image sensor 16a. A number of other elements will also be understood to be included in the camera. The image sensor 16a may vary, and may include, e.g., charge coupled devices or CMOS technology. The camera 12b includes similar elements, such as lens 14b and image sensor 16b. The fields of view of the cameras are also illustrated.

The camera 12a is provided on the mount 18a, which may be motorized. Similarly, the camera 12b is mounted on a motorized mount 18b. In FIG. 1, the camera 12b was initially at an interaxial separation IA_{AB} (shown in dotted lines) but has been moved closer to the camera 12a, to an interaxial separation IA_{AB′} (the camera 12b then shown in solid lines). The movement to IA_{AB′} may have been performed for a number of reasons, and is generally related to the desire and artistic direction of the director, photographer, or filmmaker. Choice in the selection of IA is normally provided by one or more motorized mounts which allows the separation between the optical centers of the left and right cameras or “eyes” to be adjusted.

### SUMMARY OF THE INVENTION

Systems and methods are provided for 3-D photography. In one exemplary implementation, multiple cameras or lens and sensor assemblies are employed to provide a range of interaxial separations. In this way, the cost and complexity of providing an adjustable interaxial separation via motorized mounts is avoided by instead using multiple low—cost cameras and varying which cameras are used, in order to achieve varying separations. In other words, a user selects two of such cameras to achieve a desired interaxial separation, the two cameras separated by an IA closest to that desired. The systems and methods may be applicable to even low—cost consumer—grade still and video cameras to provide stereoscopic 3-D effects.

In one implementation of the new system, as an alternative to a motorized adjustment between two cameras to vary their interaxial separation, a stereoscopic 3-D camera system incorporates several such cameras, arranged, e.g., horizontally, at various separations. The separations may be the same or may differ. A method of using the system allows for the selection of any two of these cameras at any time to serve as the left and right eyes of the stereo pair, to offer a choice of interaxial separations.

In one aspect, the invention is directed towards a system for obtaining a stereoscopic 3D image or video, including: at least three cameras, a first camera, a second camera, and a third camera, the at least three cameras disposed substantially along a line; and a control unit, the control unit for selecting which two of the at least three cameras are to be activated to substantially simultaneously receive visual data, the simultaneous reception enabling a stereoscopic 3D image or video to be constructed from the received visual data.

Implementations of the system may include one or more of the following. The axes of each lens of the at least three cameras may be substantially parallel or non-parallel. The at least three cameras may be arranged substantially along the line in order with the first camera first, the second camera second, and the third camera third, and where an interaxial separation of the first camera to the second camera is equal to an interaxial separation of the second camera to the third camera. The interaxial separations may also differ or be unequal. The system may further include a fourth camera substantially on the line on the side of the third camera opposite that of the second camera, and where an interaxial separation of the fourth camera to the third camera is not equal to either the interaxial separation between the first camera and the second camera or to the interaxial separation between the second camera and the third camera. The control unit may be under operator control or under control of a computer application.

In another aspect, the invention is directed towards a method for obtaining a stereoscopic 3D image or video, including: for a desired scene to be recorded as a stereoscopic image or video using two cameras, determining a desired interaxial separation of the cameras; choosing, from a system including at least three cameras, including a first camera, a second camera, and a third camera, two of the cameras having an appropriate interaxial separation given the desired interaxial separation; and activating the two cameras substantially simultaneously to receive visual data, the simultaneous activation enabling a stereoscopic 3D image or video to be constructed from the received visual data.

Implementations of the invention may include one or more of the following. The at least three cameras may be disposed substantially along a line. The choosing may be performed by a control unit, and the control unit may further perform the determining The determining may be performed using a focus distance of the scene. The choosing may further include choosing from a system including four cameras. The four cameras may be arranged substantially along the line in order with the first camera first, the second camera second, the third camera third, and the fourth camera fourth, and where each set of nearest neighbor cameras has associated therewith an interaxial separation, and where each interaxial separation is unique. The activating may include taking a photographic image. The appropriate interaxial separation may be equal to the desired interaxial separation, substantially equal to the desired interaxial separation, within 10% of the desired interaxial separation, or the like.

In another aspect, the invention is directed towards a non-transitory computer readable medium, including instructions for causing a computing device to perform the above method.

In another aspect, the invention is directed towards a system for obtaining a stereoscopic 3D image or video, including: at least three cameras, a first camera, a second camera, and a third camera; and a control unit, the control unit for selecting which two of the at least three cameras are to be activated to substantially simultaneously receive visual data, the simultaneous reception enabling a stereoscopic 3D image or video to be constructed from the received visual data.

Advantages of certain implementations of the invention may include one or more of the following. Even low—cost consumer—grade still and video cameras may be employed to achieve superior stereoscopic 3-D results. The cost of motorized systems providing adjustable interaxial separation of cameras is avoided.

### BRIEF DESCRIPTION OF THE DRAWINGS

FIG. 1 illustrates a top plan view of a prior art stereoscopic 3-D camera system.

FIG. 2 illustrates a top plan view of a first embodiment of a stereoscopic 3-D camera system according to the principles described here.

FIG. 3 illustrates a plan view of another embodiment of a stereoscopic 3-D camera system according to the principles described here, particularly illustrating a control system.

FIG. 4 is a flowchart of a method for using a stereoscopic 3-D camera system according to the principles described here.

FIG. 5 illustrates a top plan view of a first embodiment of a stereoscopic 3-D camera system according to the principles described here.

### DETAILED DESCRIPTION

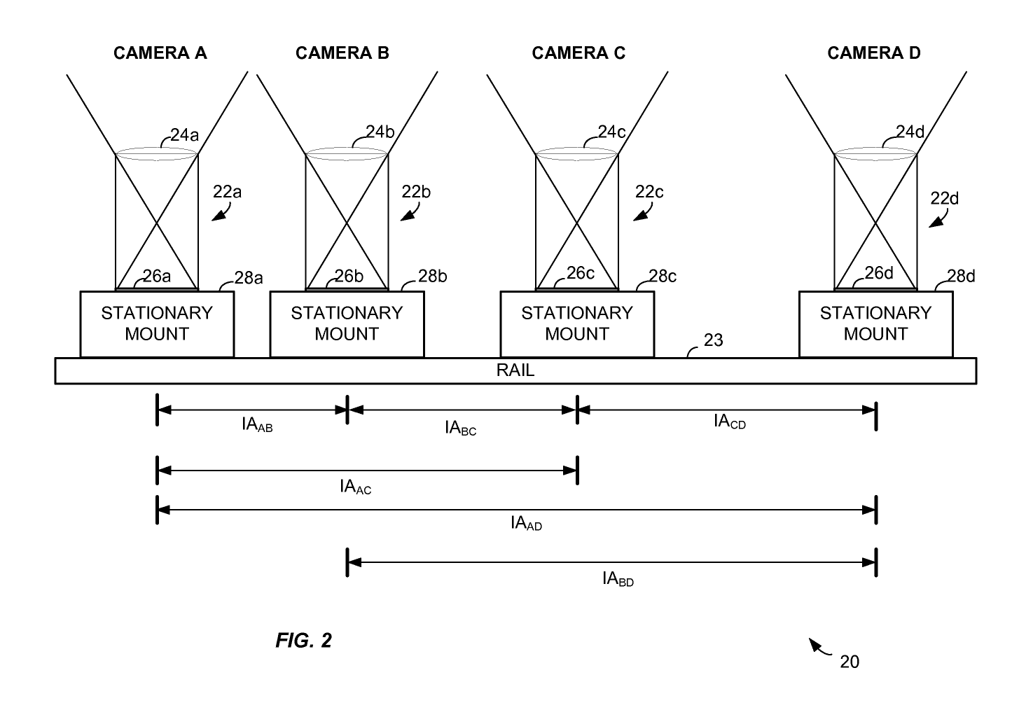

Referring to FIG. 2, a system 20 is illustrated in which four stationary cameras A-D (with exemplary reference numerals 22a-22d) provide a range of interaxial separations to a user, any two of which are employable in a given shot for creation of a stereoscopic three-dimensional image, either still or video. It will be understood that any number of cameras may be employed to give a range of interaxial separations. Each camera comprises a lens and sensor assembly, and the camera is occasionally termed such in this disclosure.

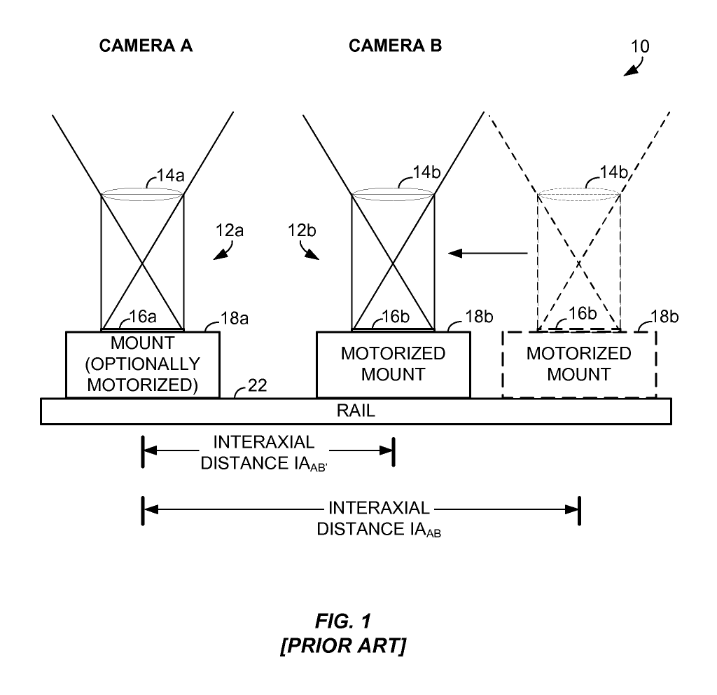

As in FIG. 1, the cameras 22i are shown in highly schematic form, as including a lens 24i and an image sensor 26i, and as before a number of other elements will also be understood. Moreover, while the cameras are typically identical, the cameras 22i may, in an alternative implementation, differ from each other, e.g., the cameras may differ in make, model, characteristics, specifications, or the like. The differences may be in lenses, modes, image sensors, and so on. The image sensors 26i may vary, and may include any devices on which an image may be received and stored, including those employing charge coupled devices, CMOS technology, and the like.

In FIG. 2, the cameras 22i are provided on stationary mounts 28i. In some cases, one or more of the mounts 28i may be motorized, but this is not necessary. The stationary mounts 28i are mounted on a rail 23, and the mounts, while stationary, may in some cases be moved and temporarily located at one or more positions on the rail 23. In this way, a range of interaxial separations may be set up for a given type of shot, and all shots of that type may be taken accordingly. When another range of interaxial separations are needed, the mounts 28i may be moved to other positions and the steps repeated. In another implementation, the stationary mounts 28i are immovable, i.e., the cameras 22i maintain their fixed positions with respect to each other.

The cameras 22i are separated by a range of interaxial separations IA_{XY}, where X and Y represent the pair of cameras employed to enable creation of a given stereoscopic 3-D image or video. In FIG. 2, the following interaxial separations are apparent:

| CAMERA | CAMERA | INTERAXIAL SEPARATION |
|---|---|---|
| A | B | IA_{AB} |
| A | C | IA_{AC} |
| A | D | IA_{AD} |
| B | C | IA_{BC} |
| B | D | IA_{BD} |
| C | D | IA_{CD} |

As with the situation in FIG. 1, the choice of interaxial separation may be made for a number of reasons, and is generally related to the desire and artistic direction of the director, photographer, or filmmaker. Typically the choice can be driven by focus distance, which may be determined manually or automatically. In other words, the system can use the focus distance to determine the optimum IA.

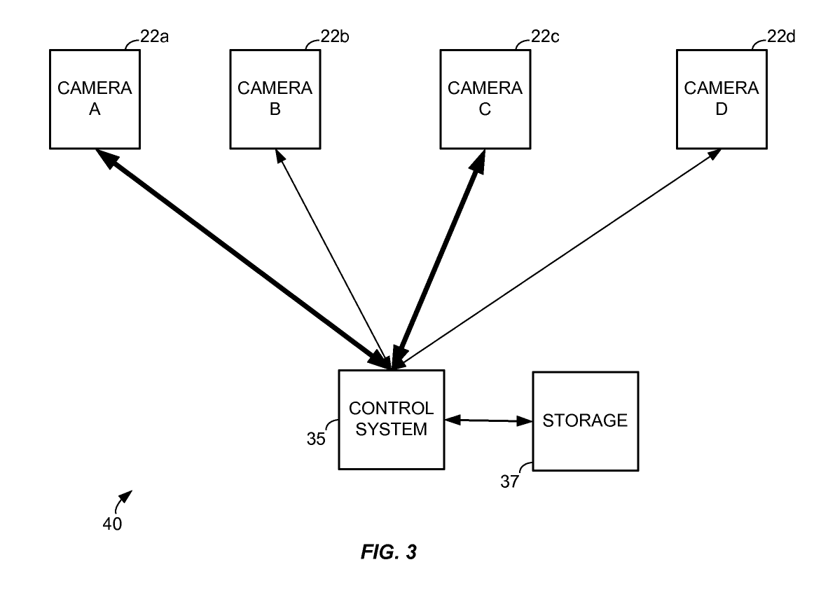

Referring to the system 40 of FIG. 3, once the desired IA is selected, a camera pair can be selected having an IA closest to that desired. If multiple camera pairs meet this criterion, another criterion can be employed to resolve which camera pair should take the shot, or alternatively other camera pairs may be chosen according to the dictates of the user or director.

The selection of the camera pair may be by way of a control system 35 which may be resident on firmware, software, or other computer application within the camera, or externally controlled, e.g., by a computer or other processor-driven system, or via a combination of these. The control system 35 operates the system so as to cause the camera pair to take a photographic or video image of the scene, and further operates to cause the image or video pair from the selected cameras to be retrieved from the cameras and stored in storage 37, e.g., for future processing. In one implementation, the storage 37 may be on board the control system 35, or on the cameras themselves.

In an alternative implementation, the selection of the pair of cameras may be entirely manual and controlled by the user.

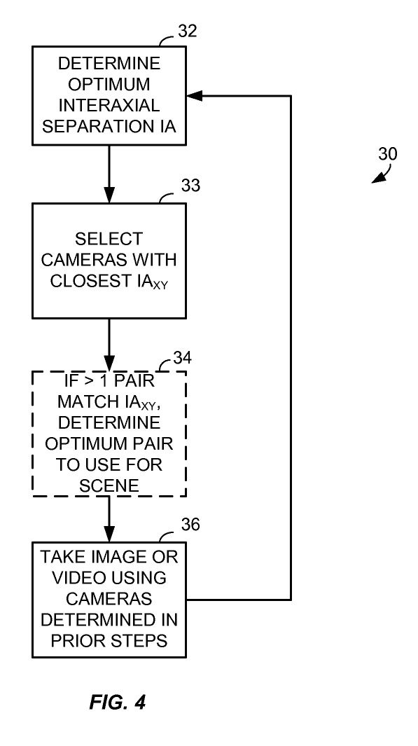

Referring to FIG. 4, a flowchart 30 is depicted showing an exemplary method of the invention. A first step of the method is determining the optimum interaxial separation IA_{XY} (step 32). This may vary based on the type of shot. For example, for scenes in which a subject is distant, an interaxial separation approximating that of human eyes is appropriate. In contrast, for close-up scenes, a narrower interaxial separation may be employed for viewing comfort.

A next step is to select a pair of cameras having an interaxial separation closest to that determined in step 32 (step 33). Generally, with a sufficient number of cameras, an interaxial separation may be found that is appropriate. In one specific implementation, four cameras having different interaxial separations have been found sufficient for most shots.

A next step, which is optional, is to select one pair of cameras out of a plurality if a plurality meet the condition of having an interaxial separation matching that determined in step 32 (step 34). In other words, if more than one pair has appropriate interaxial separations, this step determines which pair is employed for the shot. In cases where interaxial separations are all different between cameras, step 32 is generally unnecessary. If a plurality of pairs are found appropriate according to step 32, then the selection of which pair is used may be made arbitrarily, using other criteria, or by selection of the operator.

A last step is to capture the image or video using the pair of cameras determined in the prior steps (step 36). The pair selection, image capture, and storage of image data may be performed by the control system 35 described above (FIG. 3). The method may then be repeated for the next shot.

Where a switch is made between shots from one interaxial separation to another, the switch may be performed in a number of ways, including as either a cut or a dissolve which is controlled by the camera processing. Other sorts of transition will also be understood. In many cases, a quick dissolve has been found suitable.

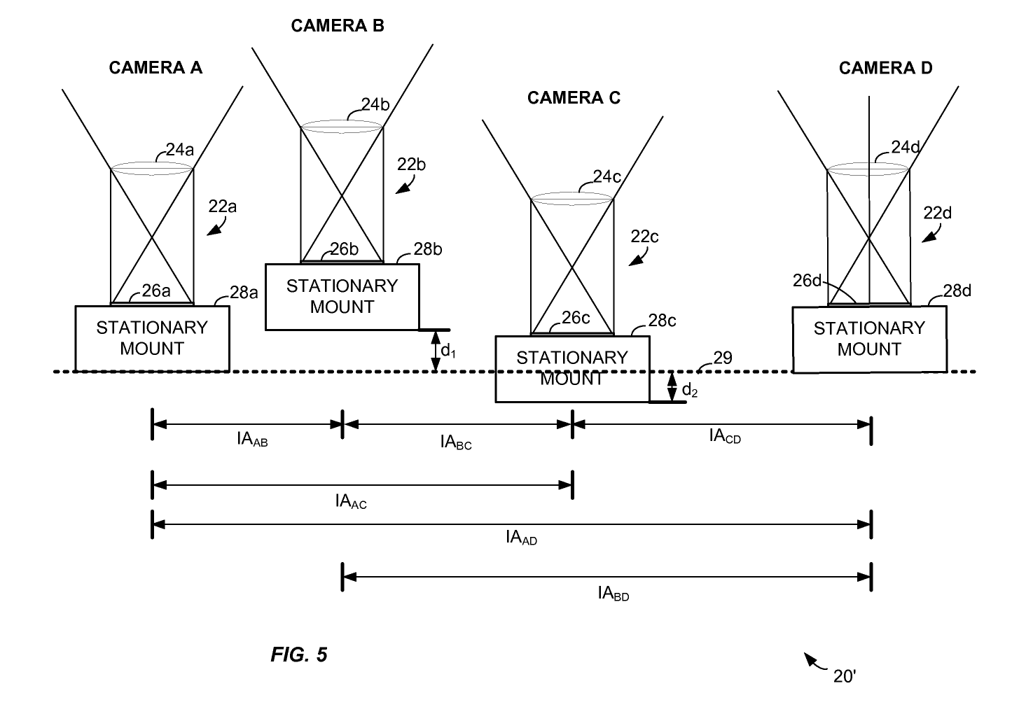

The above description has described a typical situation, in which the cameras are arranged in a straight line with the axes of the cameras, i.e., the axes of the lenses, e.g., herein termed “focal axes”, parallel to each other and perpendicular to the straight line. In this case the optical centers of the cameras will be parallel and in a horizontal plane. Other arrangements will also be understood to be encompassed by the scope of the principles described here. For example, to a certain extent, cameras may be located offset from the straight line defined above. Referring to FIG. 5, a system 20′ is illustrated in which camera B and camera C are located small distances away from the straight line 29 on which the other cameras are placed. Camera B is located a distance d₁ away from the line 29, in a direction towards the subject, and camera C is located a distance d₂ away from the line 29, in a direction away from the subject. The cameras may be placed in these positions as a result of error or to enhance a particular desired visual effect. It will be understood that variations or non-collinearity may also occur out of the plane of the page, i.e., out of the plane of the plan view defined by the line of cameras and the distances dᵢ.

Referring back to the general case of FIG. 2, the interaxial separation between cameras, i.e., the separation between their optical sensors, may be chosen to optimize the selection of interaxial separations, e.g., to provide as large a selection as possible, both in terms of the number and the range of choices.

For example, in the four-cameras system described above, if IA_{AB}=20 mm, IA_{BC}=10 mm, and IA_{CD}=15 mm, e.g., the IAs are all unique, the following interaxial separations may be obtained:

| CAMERA | CAMERA | INTERAXIAL SEPARATION |
|---|---|---|
| A | B | 20 mm |
| A | C | 30 mm |
| A | D | 45 mm |
| B | C | 10 mm |
| B | D | 25 mm |
| C | D | 15 mm |

It will be seen that minimizing the number of pairs of cameras with equal interaxial separations increases the number of interaxial separations available for the number of assemblies. If the interaxial separation between any two cameras is not equal to that between any two other cameras, this will maximize the number of unique interaxial separations available. With n assemblies, the number of unique interaxial separations is up to n(n−1)/2. For example, with four cameras, as many as six different interaxial separations are possible.

What has been described are a system and method for providing adjustable interaxial separations for cameras for 3-D stereographic photography and videography, and one which is applicable to low-cost consumer-grade still and video cameras. The cost and complexity of motorized adjustable interaxial separation are avoided by instead using multiple low-cost cameras at non-equal separations, selecting a pair of the same to achieve a desired interaxial separation.

Additional variations and implementations are also possible. For example, the stereo capture can be used to support television or movie production, or for other purposes such as videogame production. In another example, one or more lens/sensor assemblies may be provided in separate housings, such as a modular or plug-in construction or independent fixed locations. In another example, one or more lens/sensor assemblies can be manually or automatically adjusted to a secondary position. Moreover, while the system has been discussed where a director or cameraman has in mind a particular intended IA, one of ordinary skill in the art will understand numerous variations of the above; for example, a director or cameraman may simply choose any of the available IAs for a given shot. Accordingly, implementations are not limited only to the specific examples described above.

The system, particularly the pair selection and control system, and accompanying method may be fully implemented in any number of computing devices. In one exemplary implementation, a camera system includes the four lens/sensor assemblies and includes a processor to control which lens/sensor assemblies are capturing image data and providing image data to memory, and the system further controls how to process the image data being captured.

The cameras employable according to the principles described here may include those with fixed focal length lenses as well as variable focal length lenses, and may incorporate any type of analog, electronic or digital zooming.

Typically, instructions for selection and control of the cameras are laid out on computer-readable media, generally non-transitory, and these instructions are sufficient to allow a processor in the computing device to implement the method of the invention. The computer-readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the methods. Data may also be input by way of an inserted memory chip, hard drive, flash drives, flash memory, optical media, magnetic media, or any other type of file—storing medium. The outputs may be delivered to a user by way of a video graphics card or integrated graphics chipset coupled to a display that may be seen by a user. Alternatively, a printer may be employed to output hard copies of the results. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or Wi-Fi—connected device downloads a copy of the application to their device from a server using a wireless Internet connection. An appropriate authentication procedure and secure transaction process may provide for payment to be made to the seller. The application may download over the mobile connection, or over the Wi-Fi or other wireless network connection. The application may then be run by the user. Such a networked system may provide a suitable computing environment for an implementation in which a plurality of users provide separate inputs to the system and method.

1. A system for obtaining a stereoscopic 3D image or video, comprising:
a. at least three cameras, a first camera, a second camera, and a third camera, the at least three cameras disposed substantially along a line;
b. a control unit, the control unit for selecting which two of the at least three cameras are to be activated to substantially simultaneously receive visual data, the simultaneous reception enabling a stereoscopic 3D image or video to be constructed from the received visual data.

2. The system of claim 1, wherein axes of each lens of the at least three cameras are substantially parallel.

3. The system of claim 1, wherein axes of each lens of the at least three cameras are not parallel.

4. The system of claim 1, wherein the at least three cameras are arranged substantially along the line in order with the first camera first, the second camera second, and the third camera third, and wherein an interaxial separation of the first camera to the second camera is equal to an interaxial separation of the second camera to the third camera.

5. The system of claim 1, wherein the at least three cameras are arranged substantially along the line in order with the first camera first, the second camera second, and the third camera third, and wherein an interaxial separation of the first camera to the second camera is not equal to an interaxial separation of the second camera to the third camera.

6. The system of claim 1, further comprising a fourth camera substantially on the line on the side of the third camera opposite that of the second camera, and wherein an interaxial separation of the fourth camera to the third camera is not equal to either the interaxial separation between the first camera and the second camera or to the interaxial separation between the second camera and the third camera.

7. The system of claim 1, wherein the control unit is under operator control.

8. The system of claim 1, wherein the control unit is under control of a computer application.

9. A method for obtaining a stereoscopic 3D image or video, comprising:
a. for a desired scene to be recorded as a stereoscopic image or video using two cameras, determining a desired interaxial separation of the cameras;
b. choosing, from a system including at least three cameras, including a first camera, a second camera, and a third camera, two of the cameras having an appropriate interaxial separation given the desired interaxial separation; and
c. activating the two cameras substantially simultaneously to receive visual data, the simultaneous activation enabling a stereoscopic 3D image or video to be constructed from the received visual data.

10. The method of claim 9, wherein the at least three cameras are disposed substantially along a line.

11. The method of claim 9, wherein the choosing is performed by a control unit.

12. The method of claim 11, wherein the control unit further performs the determining

13. The method of claim 12, wherein the control unit further performs the determining using a focus distance of the scene.

14. The method of claim 9, wherein the choosing further comprises choosing from a system including four cameras.

15. The method of claim 14, wherein the four cameras are arranged substantially along the line in order with the first camera first, the second camera second, the third camera third, and the fourth camera fourth, and wherein each set of nearest neighbor cameras has associated therewith an interaxial separation, and wherein each interaxial separation is unique.

16. The method of claim 9, wherein the activating includes taking a photographic image.

17. The method of claim 9, wherein the appropriate interaxial separation is equal to the desired interaxial separation.

18. The method of claim 9, wherein the appropriate interaxial separation is substantially equal to the desired interaxial separation.

19. The method of claim 18, wherein the appropriate interaxial separation is within 10% of the desired interaxial separation.

20. A non-transitory computer readable medium, comprising instructions for causing a computing device to perform the method of claim 9.

21. A system for obtaining a stereoscopic 3D image or video, comprising:
a. at least three cameras, a first camera, a second camera, and a third camera;
b. a control unit, the control unit for selecting which two of the at least three cameras are to be activated to substantially simultaneously receive visual data, the simultaneous reception enabling a stereoscopic 3D image or video to be constructed from the received visual data.
